(19) United States
(12) Patent Application Publication
(10) Pub. No.: US 2024/0404412 A1
(43) Pub. Date: Dec. 5, 2024

(54) Decision Making Support for Features Published in Digital Format with Non-AIRAC Valid Time

(71) Applicant: The Boeing Company, Arlington, VA (US)

(72) Inventors: Marko Zoricic, Dreieich (DE); Milind Vasudeo Naik, Frankfurt am Main (DE); Pablo Costas Álvarez, Majadahonda (ES); Guru Tej Singh Khalsa, Dietzenbach (DE); Mary Ann Cross, Golden, CO (US)

(21) Appl. No.: 18/671,191

(22) Filed: May 22, 2024

(30) Foreign Application Priority Data
May 29, 2023 (EP) 23382503.3

(51) Int. Cl. G08G 5/00

(52) U.S. Cl. CPC G08G 5/003; G08G 5/0004

(57) ABSTRACT

Decision making support is provided. The method comprises receiving input of a current data file, wherein the current data file includes a valid time for features within the current data file. The valid time of the current data file is compared with Aeronautical Information Regulation and Control (AIRAC) cycle effective dates. Responsive to a discrepancy between the valid time of the current data file and the AIRAC cycle effective dates, the system determines if a feature change resulting from the discrepancy is flight critical. The feature change and a proposed solution with suggested text are displayed to a user in a dashboard. Responsive to input of agreement from the user to the proposed solution, the system automatically creates a change notice with the suggested text, a business process management ticket, and a data entry into a database.

### CROSS-REFERENCE TO RELATED APPLICATION

This application claims the benefit of Spanish Patent Application Serial No. EP23382503, filed May 29, 2023, and entitled “Decision Making Support for Features Published in Digital Format with Non-AIRAC Valid Time,” which is incorporated herein by reference in its entirety.

### BACKGROUND INFORMATION

### Background

The present disclosure relates generally to data management systems, and more specifically, to a system for assisting decision making by providing partial automation in presenting options to users in order to reduce manual workload.

With the transition from AIS (Aeronautical Information Service) to AIM (Aeronautical Information Management), a new data format for AISP's (Aeronautical Information Service Provider) products will be AIXM (Aeronautical Information Exchange Model) based on XML and GML. One of the primary characteristics of AIXM is temporality, which gives AIXM the possibility to have features valid for the validity period (valid time), unlike a fixed AIRAC (Aeronautical Information Regulation and Control) cycle period.

Therefore, it would be desirable to have a method and apparatus that take into account at least some of the issues discussed above, as well as other possible issues.

### SUMMARY

An illustrative embodiment provides a computer-implemented method of decision making support. The method comprises receiving input of a current data file, wherein the current data file includes a valid time for features within the current data file. The valid time of the current data file is compared with Aeronautical Information Regulation and Control (AIRAC) cycle effective dates. Responsive to a discrepancy between the valid time of the current data file and the AIRAC cycle effective dates, the system determines if a feature change resulting from the discrepancy is flight critical. The feature change and a proposed solution with suggested text are displayed to a user in a dashboard. Responsive to input of agreement from the user to the proposed solution, the system automatically creates a change notice with the suggested text, a business process management ticket, and a data entry into a database.

Another illustrative embodiment provides a system for decision making support. The system comprises a storage device that stores program instructions and one or more processors operably connected to the storage device and configured to execute the program instructions to cause the system to: receive input of a current data file, wherein the current data file includes a valid time for features within the current data file; compare the valid time of the current data file with Aeronautical Information Regulation and Control (AIRAC) cycle effective dates; responsive to a discrepancy between the valid time of the current data file and the AIRAC cycle effective dates, determine if a feature change resulting from the discrepancy is flight critical; display the feature change and a proposed solution with suggested text to a user in a dashboard; and responsive to input of agreement from the user to the proposed solution, automatically create a change notice with the suggested text, a business process management ticket, and a data entry into a database.

Another illustrative embodiment provides a computer program product for decision making support. The computer program product comprises a computer-readable storage medium having program instructions embodied thereon to perform the steps of: receiving input of a current data file, wherein the current data file includes a valid time for features within the current data file; comparing the valid time of the current data file with Aeronautical Information Regulation and Control (AIRAC) cycle effective dates; responsive to a discrepancy between the valid time of the current data file and the AIRAC cycle effective dates, determining if a feature change resulting from the discrepancy is flight critical; displaying the feature change and a proposed solution with suggested text to a user in a dashboard; and responsive to input of agreement from the user to the proposed solution, automatically creating a change notice with the suggested text, a business process management ticket, and a data entry into a database.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is a pictorial representation of a network of data processing systems in which illustrative embodiments can be implemented;

FIG. 2 is an illustration of a block diagram of a decision making support system in accordance with an illustrative embodiment;

FIG. 3 depicts a diagram illustrating a discrepancy between an AIXM file and AIRAC cycle to which the illustrative embodiments may be applied;

FIG. 4 depicts a decision making support dashboard in accordance with and illustrative embodiment;

FIG. 5 depicts a flowchart of a process for visualization within a spherical space in accordance with an illustrative embodiment; and

FIG. 6 is an illustration of a block diagram of a data processing system in accordance with an illustrative embodiment.

### DETAILED DESCRIPTION

The illustrative embodiments recognize and take into account one or more different considerations as described herein. For example, the illustrative embodiments recognize and take into account that with the transition from AIS (Aeronautical Information Service) to AIM (Aeronautical Information Management), a new data format for AISP's (Aeronautical Information Service Provider) products will be AIXM (Aeronautical Information Exchange Model) based on XML and GML.

The illustrative embodiments also recognize and take into account that one of the primary characteristics of AIXM is temporality, which gives AIXM the possibility to have features valid for the validity period (valid time), unlike a fixed AIRAC (Aeronautical Information Regulation and Control) cycle period. There are no limitations on when this validity should start or end. On the other side, the whole aviation industry, and especially FMS (Flight Management Systems) is built on the already prescribed validity periods, so-called AIRAC cycles.

The illustrative embodiments also recognize and take into account that AIRAC cycles are based on 28 days periods, and once data are incorporated into FMS, there is no possibility of changing it until the next 28-day cycle. Because of these discrepancies between AISP's products validity period and AIRAC validity period, Data houses' analysts are facing challenges in order to choose the best decision and not overlook the date discrepancy.

The illustrative embodiments also recognize and take into account that present methods contain manual steps wherein analysts have to compare validity periods provided in AIXM files and published AIRAC dates for every feature coded in AIXM file. The AIXM file can theoretically be inserted in a database, but because of FMS limitations, features which will be used for FMSs should be filtered by the validity periods. Besides validity period, analysts have to manually calculate validity period difference and check what the features changes are. Additionally, analysts must check if feature changes are flight critical or not and decide if change notices and/or request for flight alert. Additionally, analysts and standard specialists have to write change notices and flight alert manually.

The illustrative embodiments provide a system for decision-making support. A dashboard generated by the system provides analysts with options in order to make the best decision regarding next steps. Decision making support is provides in the form of options for analysts to either ingest data in the system or manually enter a solution. The system will automatically change notices and/or flight alerts for customers when required. With the implementation of this system, the decision making process can be smoother, and safety aspects will be incorporated.

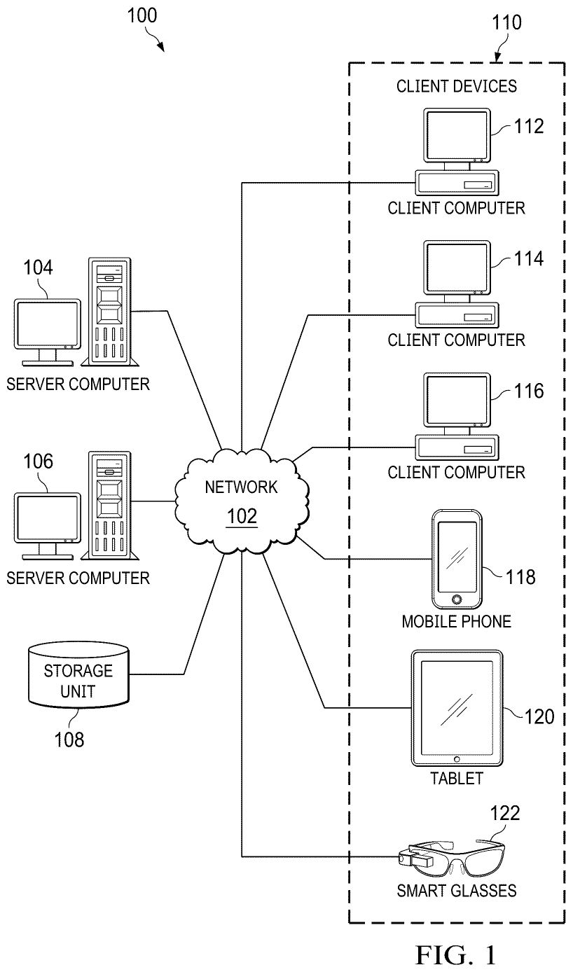

With reference to FIG. 1, a pictorial representation of a network of data processing systems is depicted in which illustrative embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 might include connections, such as wire, wireless communication links, or fiber optic cables.

In the depicted example, server computer 104 and server computer 106 connect to network 102 along with storage unit 108. In addition, client devices 110 connect to network 102. In the depicted example, server computer 104 provides information, such as boot files, operating system images, and applications to client devices 110. Client devices 110 can be, for example, computers, workstations, or network computers. As depicted, client devices 110 include client computers 112, 114, and 116. Client devices 110 can also include other types of client devices such as mobile phone 118, tablet computer 120, and smart glasses 122.

In this illustrative example, server computer 104, server computer 106, storage unit 108, and client devices 110 are network devices that connect to network 102 in which network 102 is the communications media for these network devices. Some or all of client devices 110 may form an Internet of things (IoT) in which these physical devices can connect to network 102 and exchange information with each other over network 102.

Client devices 110 are clients to server computer 104 in this example. Network data processing system 100 may include additional server computers, client computers, and other devices not shown. Client devices 110 connect to network 102 utilizing at least one of wired, optical fiber, or wireless connections.

Program code located in network data processing system 100 can be stored on a computer-recordable storage medium and downloaded to a data processing system or other device for use. For example, the program code can be stored on a computer-recordable storage medium on server computer 104 and downloaded to client devices 110 over network 102 for use on client devices 110.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers consisting of thousands of commercial, governmental, educational, and other computer systems that route data and messages. Of course, network data processing system 100 also may be implemented using a number of different types of networks. For example, network 102 can be comprised of at least one of the Internet, an intranet, a local area network (LAN), a metropolitan area network (MAN), or a wide area network (WAN). FIG. 1 is intended as an example, and not as an architectural limitation for the different illustrative embodiments.

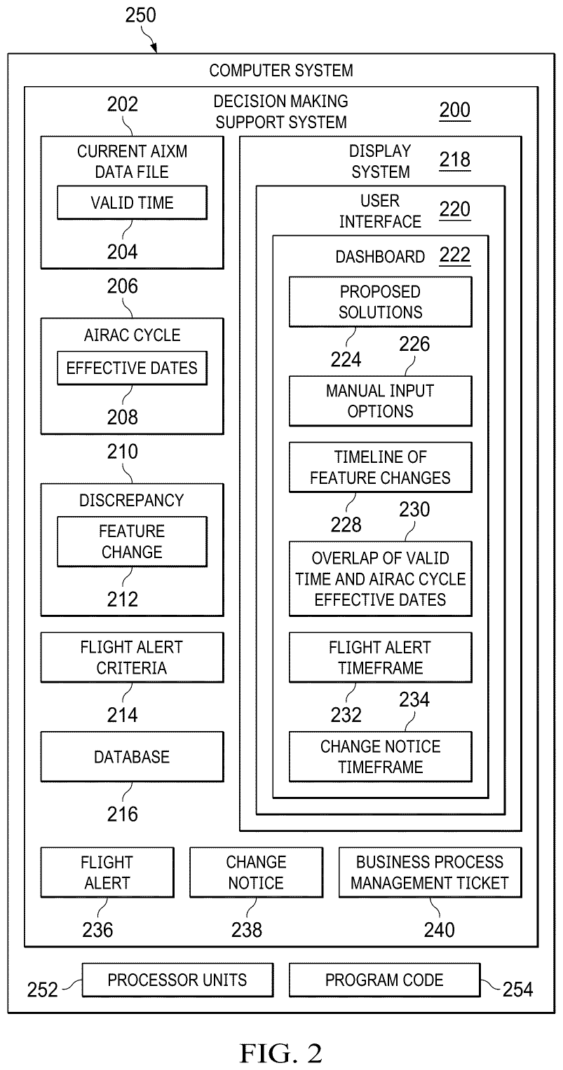

With reference now to FIG. 2, an illustration a block diagram of a decision making support system is depicted in accordance with an illustrative embodiment. In this illustrative example, decision making support system 200 includes components that can be implemented in hardware such as the hardware shown in network data processing system 100 in FIG. 1.

Decision making support system 200 ingests a current data file 202, such as an AIXM file, and compares it to an AIRAC cycle 206. Decision making support system 200 looks for any discrepancy 210 between the valid time 204 of the AIXM file and the effective dates 208 of the AIRAC cycle 206. Such a discrepancy 210 may result in a feature change 212. Feature change 212 may comprise, for example, Runway identity change. Examples of other AIXM features that may comprise feature change 212 include AirportHeloport, Airspace, Elevation, Azimuth, Route, and Glidepath.

The feature change 212 resulting from discrepancy 210 may or may not be flight critical as determined by flight alert criteria 214. For example, every altitude change would be considered flight critical, but a course change of 1 degree that is not part of the final approach procedure would not be considered flight critical. Flight alert criteria 214 may be updated regularly based on industry standards. Decision making support system 200 provides information to a user in dashboard 222 in a user interface 220 generated by display system 218. Display system 218 is a physical hardware system and includes one or more display devices on which user interface 200 can be displayed. User interface 220 can be a graphical user interface.

The display devices in display system 218 can include at least one of a light emitting diode (LED) display, a liquid crystal display (LCD), an organic light emitting diode (OLED) display, a computer monitor, a projector, a flat panel display, a heads-up display (HUD), a head-mounted display (HMD), or some other suitable device that can output information for the visual presentation of information.

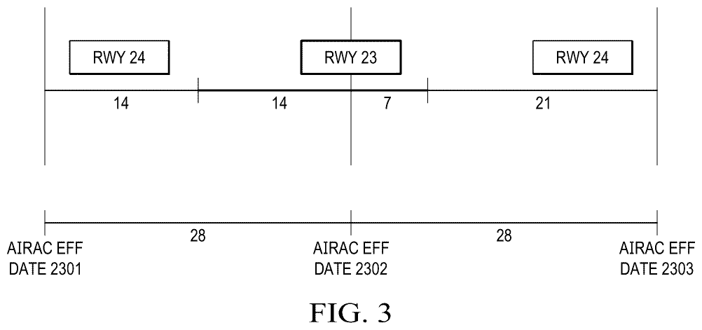

Dashboard 222 provides the user with information related to any discrepancy 210 and feature change 212 resulting from comparison of the current AIXM file 202 to the AIRAC cycle 206. This information may include a timeline of feature changes 228, overlap of valid time with the AIRAC cycle effective dates 230 (see FIG. 3), a flight alert timeframe 232, and a change notice timeframe 234.

Decision making support system 200 may display proposed solutions 224 to the user in dashboard 222. Decision making support system 200 may generate proposed solutions 224 by cross-referencing the identified feature change 212 with database 216. The user may accept and select the proposed solutions 224, in which case decision making support system 200 will automatically create a change notice 238 and business process management ticket 240 and update an entry in database 216. Database 216 may comprise, e.g., Jeppesen Aviation Database (JAD), which includes worldwide information/entities of aviation data. If the feature change 212 is flight critical, decision making support system 200 will also automatically create a flight alert 236.

If the user does not agree with the proposed solutions, dashboard 222 also displays manual input options 226 for the user to manually input a desired solution and update the database 216.

Decision making support system 200 can be implemented in software, hardware, firmware, or a combination thereof. When software is used, the operations performed by decision making support system 200 can be implemented in program code configured to run on hardware, such as a processor unit. When firmware is used, the operations performed by decision making support system 200 can be implemented in program code and data and stored in persistent memory to run on a processor unit. When hardware is employed, the hardware can include circuits that operate to perform the operations in decision making support system 200.

In the illustrative examples, the hardware can take a form selected from at least one of a circuit system, an integrated circuit, an application specific integrated circuit (ASIC), a programmable logic device, or some other suitable type of hardware configured to perform a number of operations. With a programmable logic device, the device can be configured to perform the number of operations. The device can be reconfigured at a later time or can be permanently configured to perform the number of operations. Programmable logic devices include, for example, a programmable logic array, a programmable array logic, a field programmable logic array, a field programmable gate array, and other suitable hardware devices. Additionally, the processes can be implemented in organic components integrated with inorganic components and can be comprised entirely of organic components excluding a human being. For example, the processes can be implemented as circuits in organic semiconductors.

Computer system 250 is a physical hardware system and includes one or more data processing systems. When more than one data processing system is present in computer system 250, those data processing systems are in communication with each other using a communications medium. The communications medium can be a network. The data processing systems can be selected from at least one of a computer, a server computer, a tablet computer, or some other suitable data processing system.

As depicted, computer system 250 includes a number of processor units 252 that are capable of executing program code 254 implementing processes in the illustrative examples. As used herein a processor unit in the number of processor units 252 is a hardware device and is comprised of hardware circuits such as those on an integrated circuit that respond and process instructions and program code that operate a computer. When a number of processor units 252 execute program code 254 for a process, the number of processor units 252 is one or more processor units that can be on the same computer or on different computers. In other words, the process can be distributed between processor units on the same or different computers in a computer system. Further, the number of processor units 252 can be of the same type or different type of processor units. For example, a number of processor units can be selected from at least one of a single core processor, a dual-core processor, a multi-processor core, a general-purpose central processing unit (CPU), a graphics processing unit (GPU), a digital signal processor (DSP), or some other type of processor unit.

FIG. 3 depicts a diagram illustrating a discrepancy between an AIXM file and AIRAC cycle to which the illustrative embodiments may be applied. In the present example, RWY (runway) is a feature designated with the AIXM file as RWY24 and RWY23. RWY is designated as RWY24 for 14 days (valid dates), then 21 days as RWY23, and then RWY24 again for 21 days. However, as shown in the example, the valid dates for RWY in the AIXM file are not synchronized with AIRAC effective dates. AIRAC cycle 2301 is effective for 28 days, as is AIRAC cycle 3202.

As a result of the discrepancy between the AIXM file and AIRAC cycle, FMS data will have wrong data for 14 days in AIRAC cycle 2301 and 7 or 21 days in cycle 2302. Additionally, a potential flight alert will be required.

The illustrative embodiments provide partial automation in order to give the analyst decision support and options to reduce manual workload.

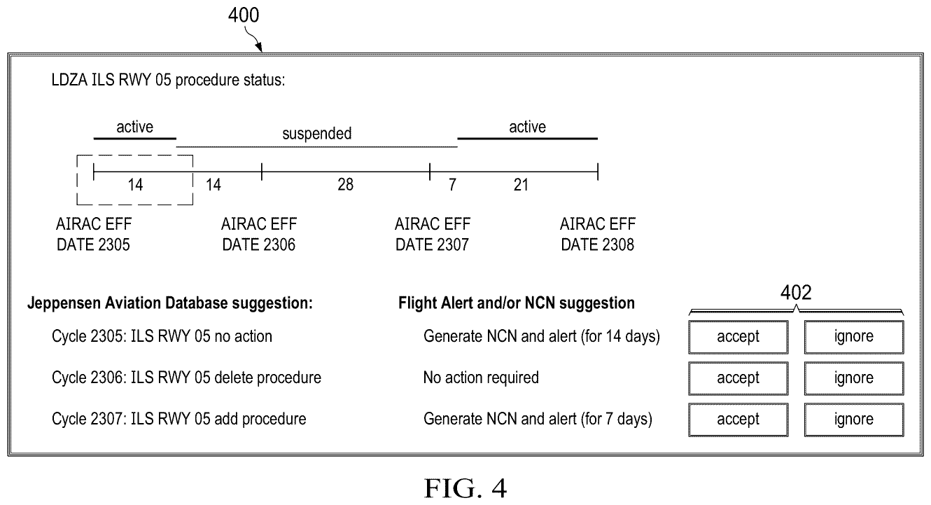

FIG. 4 depicts a decision making support dashboard in accordance with and illustrative embodiment. Dashboard 400 is a possible example implementation of dashboard 222 in FIG. 2.

In the present example, dashboard 400 is displaying an instrument landing system (ILS) approach procedure for LDZA (Zagreb) airport. The approach procedure is for Runway 5 (RWY 05).

For AIRAC Cycle 2305, the decision making support system has proposed generating a change notice and alert for 14 days to account for the discrepancy between the AIXM valid time and effective dates of AIRAC Cycle 2305. The user may choose to accept the proposed solution or ignore it using one of input buttons 402.

For AIRAC Cycle 2306, the decision making support system suggests that no action is required due to lack of discrepancy between the AIXM valid time and the AIRAC effective dates.

For AIRAC Cycle 207, the decision making support system has proposed generating a change notice and alert for 7 days to account for the discrepancy between the AIXM valid time and effective dates of AIRAC Cycle 2307.

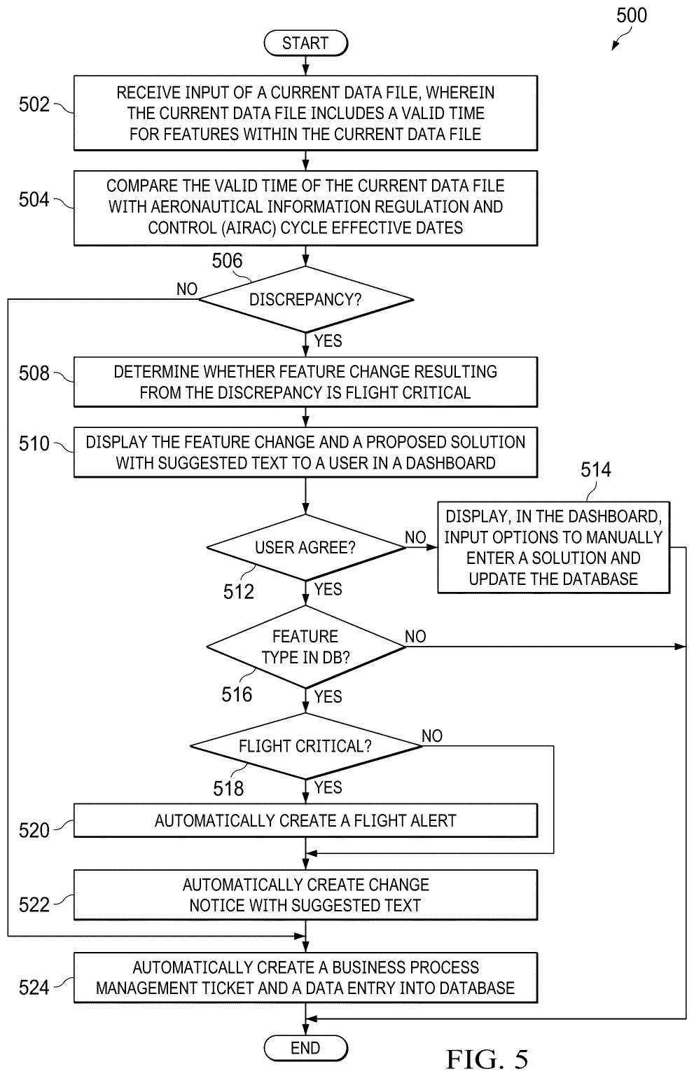

FIG. 5 depicts a flowchart of a process for decision making support in accordance with an illustrative embodiment. The process in FIG. 5 can be implemented in hardware, software, or both. When implemented in software, the process can take the form of program code that is run by one of more processor units located in one or more hardware devices in one or more computer systems. For example, the process can be implemented in decision making support system 200 in computer system 250 in FIG. 2.

Process 500 begins by receiving input of a current data file (operation 502). The current data file includes a valid time for features within the current data file. The current data file may comprise an Aeronautical Information Exchange Model (AIXM) file.

Process 500 compares the valid time of the current data file with Aeronautical Information Regulation and Control (AIRAC) cycle effective dates (operation 504) and determines if there is a discrepancy between them (operation 506). Responsive to a determination there is no discrepancy between the valid time of the current data file and the AIRAC cycle effective dates, process 500 will follow the standard process and automatically creating a business process management ticket and data entry into the database (operation 524).

Responsive to a discrepancy between the valid time of the current data file and the AIRAC cycle effective dates, process 500 determines if a feature change resulting from the discrepancy is flight critical (operation 508). Determining whether a feature change resulting from the discrepancy is flight critical comprises comparing feature changes between the current data file and a previously released data file according to specified flight alert criteria.

Process 500 displays the feature change and a proposed solution with suggested text to a user in a dashboard (operation 510). The dashboard may further display at least one of a timeline of the feature changes, overlap of the valid time with the AIRAC cycle effective dates, a timeframe of flight alert, and/or a timeframe of change notice.

The user may agree with/accept or reject proposed solution (operation 512). If the user rejects the proposed solution, responsive to input of disagreement from the user to the proposed solution, process 500 displays in the dashboard input options to manually enter a solution and update the database (operation 514).

If the user agrees with the proposed solutions, process 500 determines if the feature type affected by the change from the discrepancy is present in the database (operation 516). If the feature type is not in the database, process 500 ends.

If the feature type is in the database, process 400 will take different paths depending on whether the feature change is flight critical, as determined in operation 508 (operation 518). Responsive to input of agreement from the user to the proposed solution and a determination that the feature change is not flight, process 500 automatically creates a change notice with the suggested text (operation 522) and creates a business process management ticket and a data entry into the database (operation 524).

Responsive to a determination that the feature change is flight critical, process 500 also automatically creates a flight alert (operation 520) in addition to the change notice, business process management ticket, and database entry.

Process 500 then ends.

The flowchart and block diagrams in the different depicted embodiments illustrate the architecture, functionality, and operation of some possible implementations of apparatuses and methods in an illustrative embodiment. In this regard, each block in the flowcharts or block diagrams can represent at least one of a module, a segment, a function, or a portion of an operation or step. For example, one or more of the blocks can be implemented as program code, hardware, or a combination of the program code and hardware. When implemented in hardware, the hardware can, for example, take the form of integrated circuits that are manufactured or configured to perform one or more operations in the flowcharts or block diagrams. When implemented as a combination of program code and hardware, the implementation may take the form of firmware. Each block in the flowcharts or the block diagrams can be implemented using special purpose hardware systems that perform the different operations or combinations of special purpose hardware and program code run by the special purpose hardware.

In some alternative implementations of an illustrative embodiment, the function or functions noted in the blocks may occur out of the order noted in the figures. For example, in some cases, two blocks shown in succession may be performed substantially concurrently, or the blocks may sometimes be performed in the reverse order, depending upon the functionality involved. Also, other blocks may be added in addition to the illustrated blocks in a flowchart or block diagram.

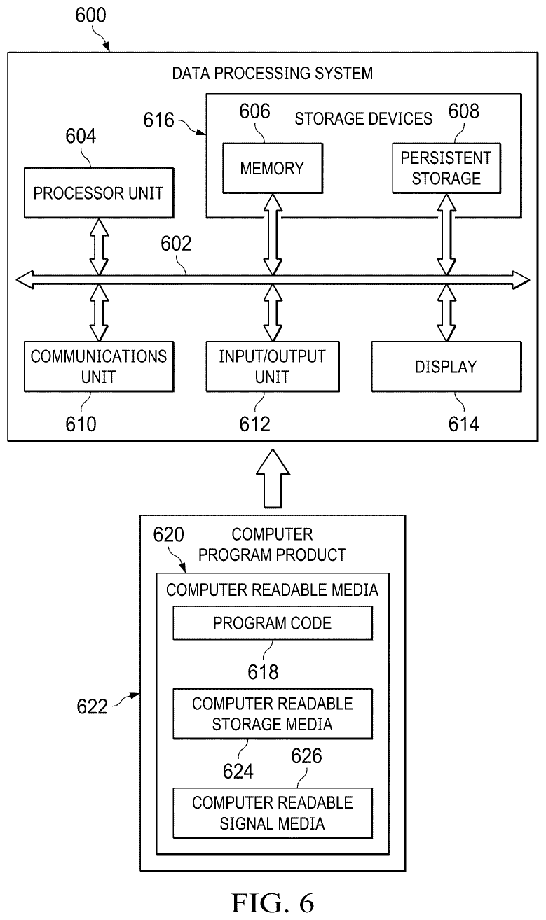

Turning now to FIG. 6, an illustration of a block diagram of a data processing system is depicted in accordance with an illustrative embodiment. Data processing system 600 may be used to implement server computers 104 and 106 and client devices 110 in FIG. 1, as well as computer system 250 in FIG. 2. In this illustrative example, data processing system 600 includes communications framework 602, which provides communications between processor unit 604, memory 606, persistent storage 608, communications unit 610, input/output (I/O) unit 612, and display 614. In this example, communications framework 602 takes the form of a bus system.

Processor unit 604 serves to execute instructions for software that may be loaded into memory 606. Processor unit 604 may be a number of processors, a multi-processor core, or some other type of processor, depending on the particular implementation. In an embodiment, processor unit 604 comprises one or more conventional general-purpose central processing units (CPUs). In an alternate embodiment, processor unit 604 comprises one or more graphical processing units (GPUs).

Memory 606 and persistent storage 608 are examples of storage devices 616. A storage device is any piece of hardware that is capable of storing information, such as, for example, without limitation, at least one of data, program code in functional form, or other suitable information either on a temporary basis, a permanent basis, or both on a temporary basis and a permanent basis. Storage devices 616 may also be referred to as computer-readable storage devices in these illustrative examples. Memory 606, in these examples, may be, for example, a random access memory or any other suitable volatile or non-volatile storage device. Persistent storage 608 may take various forms, depending on the particular implementation.

For example, persistent storage 608 may contain one or more components or devices. For example, persistent storage 608 may be a hard drive, a flash memory, a rewritable optical disk, a rewritable magnetic tape, or some combination of the above. The media used by persistent storage 608 also may be removable. For example, a removable hard drive may be used for persistent storage 608. Communications unit 610, in these illustrative examples, provides for communications with other data processing systems or devices. In these illustrative examples, communications unit 610 is a network interface card.

Input/output unit 612 allows for input and output of data with other devices that may be connected to data processing system 600. For example, input/output unit 612 may provide a connection for user input through at least one of a keyboard, a mouse, or some other suitable input device. Further, input/output unit 612 may send output to a printer. Display 614 provides a mechanism to display information to a user.

Instructions for at least one of the operating system, applications, or programs may be located in storage devices 616, which are in communication with processor unit 604 through communications framework 602. The processes of the different embodiments may be performed by processor unit 604 using computer-implemented instructions, which may be located in a memory, such as memory 606.

These instructions are referred to as program code, computer-usable program code, or computer-readable program code that may be read and executed by a processor in processor unit 604. The program code in the different embodiments may be embodied on different physical or computer-readable storage media, such as memory 606 or persistent storage 608.

Program code 618 is located in a functional form on computer-readable media 620 that is selectively removable and may be loaded onto or transferred to data processing system 600 for execution by processor unit 604. Program code 618 and computer-readable media 620 form computer program product 622 in these illustrative examples. In one example, computer-readable media 620 may be computer-readable storage media 624 or computer-readable signal media 626.

In these illustrative examples, computer-readable storage media 624 is a physical or tangible storage device used to store program code 618 rather than a medium that propagates or transmits program code 618. Computer readable storage media 624, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Alternatively, program code 618 may be transferred to data processing system 600 using computer-readable signal media 626. Computer-readable signal media 626 may be, for example, a propagated data signal containing program code 618. For example, computer-readable signal media 626 may be at least one of an electromagnetic signal, an optical signal, or any other suitable type of signal. These signals may be transmitted over at least one of communications links, such as wireless communications links, optical fiber cable, coaxial cable, a wire, or any other suitable type of communications link.

The different components illustrated for data processing system 600 are not meant to provide architectural limitations to the manner in which different embodiments may be implemented. The different illustrative embodiments may be implemented in a data processing system including components in addition to or in place of those illustrated for data processing system 600. Other components shown in FIG. 6 can be varied from the illustrative examples shown. The different embodiments may be implemented using any hardware device or system capable of running program code 618.

As used herein, the phrase “at least one of,” when used with a list of items, means different combinations of one or more of the listed items can be used, and only one of each item in the list may be needed. In other words, “at least one of” means any combination of items and number of items may be used from the list, but not all of the items in the list are required. The item can be a particular object, a thing, or a category.

For example, without limitation, “at least one of item A, item B, or item C” may include item A, item A and item B, or item B. This example also may include item A, item B, and item C or item B and item C. Of course, any combinations of these items can be present. In some illustrative examples, “at least one of” can be, for example, without limitation, two of item A; one of item B; and ten of item C; four of item B and seven of item C; or other suitable combinations.

As used herein, “a number of” when used with reference to items, means one or more items. For example, “a number of different types of networks” is one or more different types of networks. In illustrative example, a “set of” as used with reference items means one or more items. For example, a set of metrics is one or more of the metrics.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component can be configured to perform the action or operation described. For example, the component can have a configuration or design for a structure that provides the component an ability to perform the action or operation that is described in the illustrative examples as being performed by the component. Further, to the extent that terms “includes”, “including”, “has”, “contains”, and variants thereof are used herein, such terms are intended to be inclusive in a manner similar to the term “comprises” as an open transition word without precluding any additional or other elements.

Many modifications and variations will be apparent to those of ordinary skill in the art. Further, different illustrative embodiments may provide different features as compared to other desirable embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

Some features of the illustrative examples are described in the following clauses. These clauses are examples of features not intended to limit other illustrative examples.

### Clause 1

A computer-implemented method of decision
making support, the method comprising:
using a number of processors to perform the operations of:
receiving input of a current data file, wherein the current data file includes a valid time for features within the current data file;
comparing the valid time of the current data file with Aeronautical Information Regulation and Control (AIRAC) cycle effective dates;
responsive to a discrepancy between the valid time of the current data file and the AIRAC cycle effective dates, determining if a feature change resulting from the discrepancy is flight critical;
displaying the feature change and a proposed solution with suggested text to a user in a dashboard; and
responsive to input of agreement from the user to the proposed solution, automatically creating a change notice with the suggested text, a business process management ticket, and a data entry into a database.

### Clause 2

The method of clause 1, further comprising, responsive to a determination that the feature change is flight critical, automatically creating a flight alert.

### Clause 3

The method of clause 1 or 2, further comprising, responsive to a determination there is no discrepancy between the valid time of the current data file and the AIRAC cycle effective dates, automatically creating only the business process management ticket and the data entry into the database.

### Clause 4

The method of any of clauses 1 to 3, further comprising, responsive to input of disagreement from the user to the proposed solution, displaying, in the dashboard, input options to manually enter a solution and update the database.

### Clause 5

The method of any of clauses 1 to 4, wherein the current data file comprises an Aeronautical Information Exchange Model (AIXM) file.

### Clause 6

The method of any of clauses 1 to 5, wherein determining whether a feature change resulting from the discrepancy is flight critical comprises comparing feature changes between the current data file and a previously released data file according to specified flight alert criteria.

### Clause 7

The method of any of clauses 1 to 6, wherein the dashboard further displays at least one of:
a timeline of the feature changes;
overlap of the valid time with the AIRAC cycle effective dates;
a timeframe of flight alert; or
a timeframe of change notice.

### Clause 8

A system for decision making support, the system comprising:
a storage device that stores program instructions;
   one or more processors operably connected to the storage device and configured to execute the program instructions to cause the system to:
receive input of a current data file, wherein the current data file includes a valid time for features within the current data file;
compare the valid time of the current data file with Aeronautical Information Regulation and Control (AIRAC) cycle effective dates;
responsive to a discrepancy between the valid time of the current data file and the AIRAC cycle effective dates, determine if a feature change resulting from the discrepancy is flight critical;
display the feature change and a proposed solution with suggested text to a user in a dashboard; and
responsive to input of agreement from the user to the proposed solution, automatically create a change notice with the suggested text, a business process management ticket, and a data entry into a database.

### Clause 9

The system of clause 8, further comprising, responsive to a determination that the feature change is flight critical, automatically creating a flight alert.

### Clause 10

The system of clause 8 or 9, further comprising, responsive to a determination there is no discrepancy between the valid time of the current data file and the AIRAC cycle effective dates, automatically creating only the business process management ticket and the data entry into the database.

### Clause 11

The system of any of clauses 8 to 10, further comprising, responsive to input of disagreement from the user to the proposed solution, displaying, in the dashboard, input options to manually enter a solution and update the database.

### Clause 12

The system of any of clauses 8 to 11, wherein the current data file comprises an Aeronautical Information Exchange Model (AIXM) file.

### Clause 13

The system of any of clauses 8 to 12, wherein determining whether a feature change resulting from the discrepancy is flight critical comprises comparing feature changes between the current data file and a previously released data file according to specified flight alert criteria.

### Clause 14

The system of any of clause 8 to 13, wherein the dashboard further displays at least one of:
a timeline of the feature changes;
overlap of the valid time with the AIRAC cycle effective dates;
a timeframe of flight alert; or
a timeframe of change notice.

### Clause 15

A computer program product for decision making support, the computer program product comprising:
a computer-readable storage medium having
program instructions embodied thereon to perform the steps of:
receiving input of a current data file, wherein
the current data file includes a valid time for features within the current data file;
comparing the valid time of the current data file with Aeronautical Information Regulation and Control (AIRAC) cycle effective dates;
responsive to a discrepancy between the valid time of the current data file and the AIRAC cycle effective dates, determining if a feature change resulting from the discrepancy is flight critical;
displaying the feature change and a proposed solution with suggested text to a user in a dashboard; and
responsive to input of agreement from the user to the proposed solution, automatically creating a change notice with the suggested text, a business process management ticket, and a data entry into a database.

### Clause 16

The computer program product of clause 15, further comprising, responsive to a determination that the feature change is flight critical, automatically creating a flight alert.

### Clause 17

The computer program product of clause 15 or 16, further comprising, responsive to a determination there is no discrepancy between the valid time of the current data file and the AIRAC cycle effective dates, automatically creating only the business process management ticket and the data entry into the database.

### Clause 18

The computer program product of any of clauses 15 to 17, further comprising, responsive to input of disagreement from the user to the proposed solution, displaying, in the dashboard, input options to manually enter a solution and update the database.

### Clause 19

The computer program product of any of clauses 15 to 18, wherein determining whether a feature change resulting from the discrepancy is flight critical comprises comparing feature changes between the current data file and a previously released data file according to specified flight alert criteria.

### Clause 20

The computer program product of any of clauses 15 to 19, wherein the dashboard further displays at least one of:
a timeline of the feature changes;
overlap of the valid time with the AIRAC cycle effective dates;
a timeframe of flight alert; or
a timeframe of change notice.

What is claimed is:

1. A computer-implemented method of decision making support, the method comprising:
using a number of processors to perform the operations of:
receiving input of a current data file, wherein the current data file includes a valid time for features within the current data file;
comparing the valid time of the current data file with an Aeronautical Information Regulation and Control (AIRAC) cycle effective dates;
responsive to a discrepancy between the valid time of the current data file and the AIRAC cycle effective dates, determining if a feature change resulting from the discrepancy is flight critical;
displaying the feature change and a proposed solution with suggested text to a user in a dashboard; and
responsive to input of agreement from the user to the proposed solution, automatically creating a change notice with the suggested text, a business process management ticket, and a data entry into a database.

2. The method of claim 1, further comprising, responsive to a determination that the feature change is flight critical, automatically creating a flight alert.

3. The method of claim 1, further comprising, responsive to a determination there is no discrepancy between the valid time of the current data file and the AIRAC cycle effective dates, automatically creating only the business process management ticket and the data entry into the database.

4. The method of claim 1, further comprising, responsive to input of disagreement from the user to the proposed solution, displaying, in the dashboard, input options to manually enter a solution and update the database.

5. The method of claim 1, wherein the current data file comprises an Aeronautical Information Exchange Model (AIXM) file.

6. The method of claim 1, wherein determining whether a feature change resulting from the discrepancy is flight critical comprises comparing feature changes between the current data file and a previously released data file according to specified flight alert criteria.

7. The method of claim 1, wherein the dashboard further displays at least one of:
a timeline of the feature changes;
overlap of the valid time with the AIRAC cycle effective dates;
a timeframe of flight alert; or
a timeframe of change notice.

8. A system for decision making support, the system comprising:
a storage device that stores program instructions;
one or more processors operably connected to the storage device and configured to execute the program instructions to cause the system to:
receive input of a current data file, wherein the current data file includes a valid time for features within the current data file;
compare the valid time of the current data file with an Aeronautical Information Regulation and Control (AIRAC) cycle effective dates;
responsive to a discrepancy between the valid time of the current data file and the AIRAC cycle effective dates, determine if a feature change resulting from the discrepancy is flight critical;
display the feature change and a proposed solution with suggested text to a user in a dashboard; and
responsive to input of agreement from the user to the proposed solution, automatically create a change notice with the suggested text, a business process management ticket, and a data entry into a database.

9. The system of claim 8, further comprising, responsive to a determination that the feature change is flight critical, automatically creating a flight alert.

10. The system of claim 8, further comprising, responsive to a determination there is no discrepancy between the valid time of the current data file and the AIRAC cycle effective dates, automatically creating only the business process management ticket and the data entry into the database.

11. The system of claim 8, further comprising, responsive to input of disagreement from the user to the proposed solution, displaying, in the dashboard, input options to manually enter a solution and update the database.

12. The system of claim 8, wherein the current data file comprises an Aeronautical Information Exchange Model (AIXM) file.

13. The system of claim 8, wherein determining whether a feature change resulting from the discrepancy is flight critical comprises comparing feature changes between the current data file and a previously released data file according to specified flight alert criteria.

14. The system of claim 8, wherein the dashboard further displays at least one of:
a timeline of the feature changes;
overlap of the valid time with the AIRAC cycle effective dates;
a timeframe of flight alert; or
a timeframe of change notice.

15. A computer program product for decision making support, the computer program product comprising:
a computer-readable storage medium having program instructions embodied thereon to perform the steps of:
receiving input of a current data file, wherein the current data file includes a valid time for features within the current data file;
comparing the valid time of the current data file with an Aeronautical Information Regulation and Control (AIRAC) cycle effective dates;
responsive to a discrepancy between the valid time of the current data file and the AIRAC cycle effective dates, determining if a feature change resulting from the discrepancy is flight critical;
displaying the feature change and a proposed solution with suggested text to a user in a dashboard; and
responsive to input of agreement from the user to the proposed solution, automatically creating a change notice with the suggested text, a business process management ticket, and a data entry into a database.

16. The computer program product of claim 15, further comprising, responsive to a determination that the feature change is flight critical, automatically creating a flight alert.

17. The computer program product of claim 15, further comprising, responsive to a determination there is no discrepancy between the valid time of the current data file and the AIRAC cycle effective dates, automatically creating only the business process management ticket and the data entry into the database.

18. The computer program product of claim 15, further comprising, responsive to input of disagreement from the user to the proposed solution, displaying, in the dashboard, input options to manually enter a solution and update the database.

19. The computer program product of claim 15, wherein determining whether a feature change resulting from the discrepancy is flight critical comprises comparing feature changes between the current data file and a previously released data file according to specified flight alert criteria.

20. The computer program product of claim 15, wherein the dashboard further displays at least one of:
a timeline of the feature changes;
overlap of the valid time with the AIRAC cycle effective dates;
a timeframe of flight alert; or
a timeframe of change notice.
